(19) United States
(12) Patent Application Publication
(10) Pub. No.: US 2004/0086112 A1
(43) Pub. Date: May 6, 2004

(54) Cell phone holder for an automobile

(76) Inventors: Daniel Hilger, Chino, CA (US); Chris Vanderhagen, Orange, CA (US)

Correspondence Address: GENE SCOTT; PATENT LAW & VENTURE GROUP, 3140 RED HILL AVENUE, SUITE 150, COSTA MESA, CA, 92626-3440, US

(21) Appl. No.: 10/285,828

(22) Filed: Nov. 1, 2002

(51) Int. Cl. H04M 1/00

(52) U.S. Cl. 379/455; 379/441

(57) ABSTRACT

An apparatus for holding a communication device, comprising in combination, a cup holder having a recess therein; a cell phone; and a circular body of an elastic material. The body has an upper portion of a constant first diameter and a lower portion of a second smaller constant diameter. The upper and lower portions are smoothly joined by a transition portion. The upper portion terminates with an upper surface defining a rectangular recess enabled for receiving the cell phone with the cell phone protruding upwardly from the rectangular recess. The cup holder removably receives the lower portion and wedgingly grips the transitional portion of the body in frictional compliant engagement.

### BACKGROUND OF THE INVENTION

INCORPORATION BY REFERENCE: Applicant(s) hereby incorporate herein by reference, any and all U.S. patents, U.S. patent applications, and other documents and printed matter cited or referred to in this application.

1. Field of the Invention

This invention relates generally to cell phone holders in an automobile or other vehicle and more particularly to a one piece, integral body of elastic material with vertical sidewalls and a transition section capable of wedging the body in a drink recess in the vehicle.

2. Description of Related Art

The following art defines the present state of this field:

Golder, U.S. Des. 402,666, describes a support for receipt in a cup holder design.

Hoff, U.S. Des. 407,408, describes a phone holder design.

Richter, U.S. Des. 451,095 describes a mobile telephone holder design.

Edwards, U.S. Des. 451,504 describes a cell cup design.

Kohli, U.S. Des. 452,236 describes a cup-holder speaker phone design.

Bridges, U.S. Pat. No. 5,651,523 describes a system for supporting at least one article, comprising an article support member and a base support member for supporting a base member of the article support. The article support comprises a member comprising a first end including a base member projecting therefrom, and a second end including an article support portion capable of supporting at least one article. The base support member comprises a wall, which defines a cavity for receiving a portion of the base member projecting from the first portion of the member. Further, the cavity is provided with a protrusion. Preferably, the base support member comprises a cup holder in an automotive vehicle. The base member comprises a first portion capable of interacting with the protrusion, and a second portion capable of interacting with the wall defining said cavity, to cause wedging in response to downward movement of the second end to thereby restrain the second end from further downward movement or in response to tilting of the base member to thereby restrain the base member from further tilting. A beverage container holder is also provided, which can accommodate beverage containers of various sizes and shapes.

Wakefield, U.S. Pat. No. 5,745,565 describes a combination beverage and cellular phone holder adapted for insertion into an existing vehicle beverage holder to convert it to a multi-unit holder and firmly position the cellular phone within the vehicle in a convenient and accessible position.

Fitzgerald, U.S. Pat. No. 5,791,460 describes a holder for temporary storage of eyeglasses particularly in a vehicle, comprising an elongated hollow cylinder made of a rubber-like, soft resilient material. A rectangular slot at one end of the cylinder is adjacent a plurality of straight die cuts forming a plurality of deformable fingers. These fingers effectively grasp an end of the folded eyeglasses physically isolating and protecting the eyeglasses, which sit, predominantly in the interior of the cylinder. The cylinder is preferably dimensioned to fit standard cup holders used in vehicles.

Amerio, Jr. et al., U.S. Pat. No. 5,903,133 describes a charger for an item to be charged comprising a base fitting into an automobile beverage holder; a means for securing the base of the beverage holder, a first electrical contact on the base to supply power to the charger; a second electrical contact on the base to supply power to the item to be charged, and a receptacle in the base for holding the item to be charged. In one embodiment of the invention, the top portion of the charger has the receptacle and the first and second electrical contacts, and may be detached from the base for use as a desk charger.

Etue, U.S. Pat. No. 6,062,518 describes a device for retaining a cellular phone in an automotive interior utilizing an existing cup holder. The device includes a base with a top portion and one or more downwardly extending gripping members for gripping the sidewall of a cup holder. A bracket for retaining a cellular phone is supported on the base. The device preferably includes an elongated extension extending upwardly from the top portion of the base and terminating in an adjustable connector, which supports the retaining bracket. The downwardly extending gripping members preferably are adjustable to allow the device to accommodate a variety of cup holders.

Wakefield, U.S. Pat. No. 6,189,755 describes a combination beverage and cellular phone holder adapted for insertion into an existing vehicle beverage holder to convert it to a multi-unit holder and firmly position the cellular phone within the vehicle in a convenient and accessible position.

Walsh, U.S. Pat. No. 6,246,766 describes a portable telephone or cell phone holder that fits in a conventional cup holder of an automobile or other vehicle. It has an arcuate sidewall that is less than 360 degrees and is resiliently deformable to be squeezed sown to less than the diameter of the cup holder and then, when released, to grip the inside surface of the cup holder. A tongue extends upwardly and radially inwardly from the sidewall to a distal end to provide a support telephone platform and has a concave slanted surface to accommodate and center a telephone belt clip.

Ericsson, Inc., WO97/42057 describes a combination beverage and cellular phone holder adapted for insertion into an existing vehicle beverage holder to convert it to a multi-unit holder and firmly position the cellular phone within the vehicle in a convenient and accessible position

Peiker, WO01/19646 describes an arrangement for operating portable, electronic appliances, such as a mobile radiotelephone, an organizer (PDA) or the like in vehicles. According to the invention, a functional unit, which is arranged in a beverage holder, is produced.

As shown, the prior art teaches a variety of apparatus and methods for supporting a cell phone in a vehicle. Cell phones are personal communication devices and, as such, are carried on ones person. When sitting in a vehicle, however, the cell phone is most conveniently placed within easy reach and within cord distance to a source of 12 volt power, such as a cigarette lighter or similar plug-in device. The necessary objectives in this situation are to prevent damage to the cell phone due to vehicle movement, and to enable easy retrieval of the phone when a call is received. Typical solutions to these issues include devices that grip the phone the interior features of the automobile, such as a cup recess, so as to avoid phone impacts. However, almost all of these solutions are relatively expensive to manufacture and difficult to use. Until now, a very low cost solution that is extremely inexpensive to make, easy to use, and that provides the necessary advantages has not been made available or disclosed in the prior art. The present invention fulfills these needs and provides further related advantages as described in the following summary.

### SUMMARY OF THE INVENTION

The present invention teaches certain benefits in construction and use which give rise to the objectives described below.

The present invention is an apparatus for holding a communication device, comprising in combination, a cup holder having a recess therein; a cell phone; and a circular body of an elastic material. The body has an upper portion of a first diameter and a lower portion of a second smaller diameter. The upper and lower portions are smoothly joined by a transition portion. The upper portion terminates with an upper surface defining a rectangular recess enabled for receiving the cell phone with the cell phone protruding upwardly from the rectangular recess. The cup holder removably receives the lower portion and wedgingly grips the transitional portion of the body in frictional compliant engagement. In this manner, the upper and lower portions, having vertical walls, use less material in forming the apparatus, relative to the divergent walls shown in the Wakefield, Golder and Edwards references described above. In other words, by placing the transition portion medially on the side walls of the apparatus, one achieves the novelty of a wedging surface while avoiding the incorporation of excess material in the apparatus, as well as maintaining a trim part that takes less space above the drink holder in which it is mounted. Furthermore, the upper portion's larger diameter affords the accommodation of a large cell phone recess as necessary for larger cell phones, while saving material of construction in the lower portion. By molding the apparatus in a single shot molding process as an integral unit, the cost of manufacture is low and no additional assembly or other fabrication steps need be taken.

A primary objective of the present invention is to provide an apparatus and method of use of such apparatus that provides advantages not taught by the prior art.

Another objective is to provide such an invention capable of very low cost manufacture.

A further objective is to provide such an invention capable of cushioned engagement for a cell phone.

A still further objective is to provide such an invention capable of being used in a wide range of cup holder types and sizes.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is a perspective exploded view of the preferred embodiment of the invention; and

FIG. 2 is a vertical cross-sectional view thereof.

### DETAILED DESCRIPTION OF THE INVENTION

The above described drawing figures illustrate the invention in at least one of its preferred embodiments, which is further defined in detail in the following description.

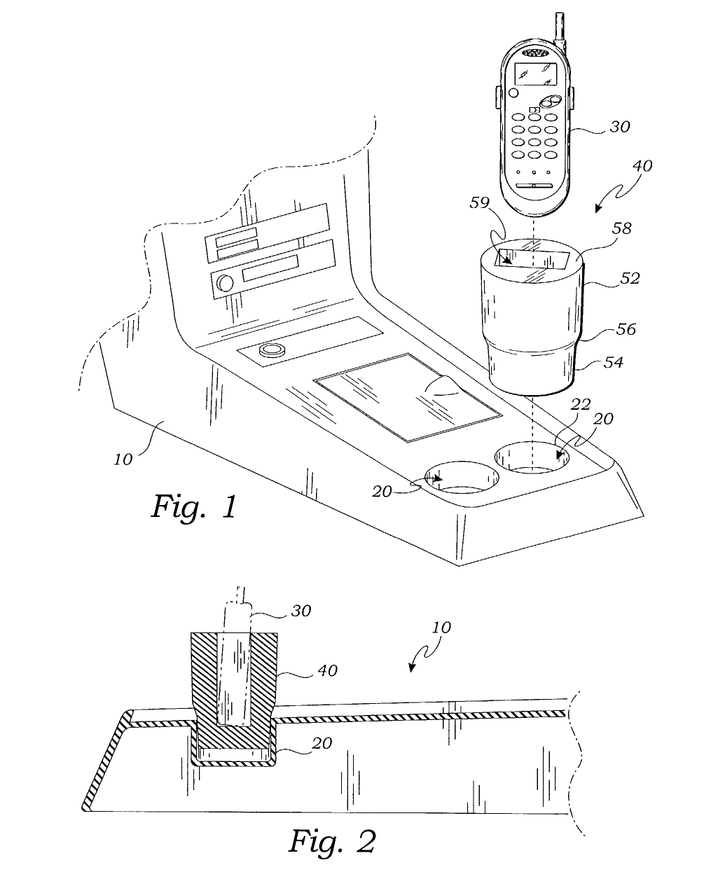

The present invention is an apparatus for conveniently positioning and storing a communication device, and particularly a cell phone within an automobile or other vehicle. The apparatus comprising in combination: an automobile utility console 10, or similar automotive utility facility, providing a cup holder recess 20 therein; a cell phone 30; and an adapter 40; for enabling the cup holder recess 20 to better receive, dispense and generally hold the cell phone. The cup holder recess 20 may be as shown in FIG. 1, or it may alternatively be a simple cup holding ring or other cup engaging device of which many types are found in modern automobiles and other vehicles such as boats, aircraft, snowmobiles, all terrain vehicles, etc. In this description, we shall refer to the cup holder device as a recess 20, and it should be understood that we also refer to the many other embodiments for holding a cup in a vehicle. The adapter 40, also referred to as “the body,” is a generally solid object having a circular shape of a lightweight, compliant or elastically deformable material such as provided by any of the foamed plastics, rubbers, plasticized rubbers and similar material. The compliancy of the material is critical in that the adapter 40 is mounted securely in the recess 20 by frictional wedging whereby the adapter 40 is slightly elastically deformed. The adapter 40 has an upper portion 52 of a first larger constant diameter and a lower portion 54 of a second slightly smaller constant diameter, wherein the upper portion 52 is too large to fit into the recess 20, but the lower portion 54 fits easily into the recess 20 as, generally, a sliding or snug fit. The upper 52 and lower 54 portions are smoothly joined by a transition portion 56, an annular surface having the first diameter where it joins the upper portion 52 and having the second diameter where it joins the lower portion 54. The transition portion 56, therefore changes in diameter smoothly as it moves between the upper 52 and the lower 54 portions. It is at the transition portion 56 where the wedging action occurs between the adapter 40 and a sidewall lip 22 of recess 20.

The upper portion 52 terminates with an horizontal upper surface 58 which defines a rectangular recess 59 extending downwardly into the adapter 40 and which is enabled by its size and shape for receiving the cell phone 30 with the cell phone 30 protruding upwardly and out from the rectangular recess 20 enough to obtain a grasp on the cell phone 30 when needed. See FIG. 2, for instance.

Preferably, the recess 20 is only slightly larger in horizontal dimensions, i.e., width and length, than the cell phone 30 so that the cell phone 30 is easily deposited, by dropping or placing it into the recess 20 and likewise, easily removed from the recess 20; yet motion of the vehicle does not cause the cell phone 30 to be unduly knocked about within the recess 20, and when such relative movement between cell phone 30 and recess 20 does occur, the elastic or energy absorbing nature of the material that the body 50 is made of, easily absorbs any shocks.

While the invention has been described with reference to at least one preferred embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

What is claimed is:

1. A phone holder apparatus comprising: a circular one-piece integral body of a shock absorbing material having a vertical walled upper portion of a first constant diameter and a vertical walled lower portion of a second constant diameter, the first diameter exceeding the second diameter, the upper and lower portions smoothly joined by a transition portion therebetween; the upper portion terminating with an upper surface defining therein a recess enabled by size for receiving a cell phone, the lower portion enabled by the second diameter for insertion into a cup holder, the transition portion of a size for being wedged tightly in the cup holder for gripping the apparatus therein.

2. An apparatus for holding a communication device, the apparatus comprising in combination: a cup holder; and a circular one-piece integral body of an elastic material, the body having a vertical walled upper portion of a first constant diameter and a vertical walled lower portion of a second constant diameter, the first diameter exceeding the second diameter, the upper and lower portions smoothly joined by a transition portion therebetween; the upper portion terminating with an upper surface defining therein a rectangular recess enabled by size for receiving a cell phone, the cup holder removably receiving the lower portion and wedgingly engaging the transitional portion in frictional compliant engagement for grippingly holding the body.

3. An apparatus for holding a communication device, the apparatus comprising in combination: a cup holder having a recess therein; a cell phone; and a circular one-piece integral body of an elastic material, the body having a vertical walled upper portion of a first constant diameter and a vertical walled lower portion of a second constant diameter, the first diameter exceeding the second diameter, the upper and lower portions smoothly joined by a transition portion therebetween; the upper portion terminating with an upper surface defining therein a rectangular recess enabled by size for slidingly receiving the cell phone, the recess of such depth to enable the cell phone to protrude outwardly from the rectangular recess, the cup holder removably receiving the lower portion and wedgingly engaging the transitional portion of the body in frictional compliant engagement for grippingly holding the body.
